(19) United States
(12) Patent Application Publication
(10) Pub. No.: US 2016/0309523 A1
(43) Pub. Date: Oct. 20, 2016

(54) REDUCING DELAY IN ATTACHMENT PROCEDURE WITH A NETWORK

(71) Applicant: QUALCOMM Incorporated, San Diego, CA (US)

(72) Inventors: Juan ZHANG, San Diego, CA (US); Ajith Tom PAYYAPPILLY, San Diego, CA (US); Vinay PARADKAR, Broomfield, CO (US); Ramachandran SUBRAMANIAN, San Diego, CA (US); Vitaly DRAPKIN, San Diego, CA (US); Cogol TINA, Mission Viejo, CA (US); Nathan Edward TENNY, Poway, CA (US)

(21) Appl. No.: 14/688,851

(22) Filed: Apr. 16, 2015

(51) Int. Cl. H04W 76/02; H04L 29/06

(52) U.S. Cl. CPC H04W 76/02; H04L 69/28

(57) ABSTRACT

Systems, methods, and apparatuses for reducing delays associated with an attachment procedure are disclosed. In accordance with the present disclosure, a user equipment (UE) may initiate an attachment procedure with a network over a non-access stratum (NAS) layer and detect a condition that may delay completion of the attachment. Based on the detection, the UE may determine whether the condition may be resolved before failure in the attachment procedure. If the UE determines that the condition can be resolved before attachment failure, the UE may suspend a timer associated with the attachment procedure at the NAS layer to allow more time for the UE to complete an authentication associated with the attachment. Conversely, if the UE determines that the condition cannot be resolved before attachment failure, the UE may abort the attachment procedure with the network and initiate a fallback attachment procedure with the network via a different base station.

### BACKGROUND

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., an LTE system).

In some multi-access systems, a communication device, which may be otherwise known as user equipment (UE), station (STA) or mobile device may communicate with the network after completing an attachment procedure that may include an authentication process. In some aspects, an extensible authentication protocol (EAP)-based authentication mechanism may be used to authenticate the communication device, where EAP is a protocol for transmitting user authentication data based on Institute of Electrical and Electronics Engineers (IEEE) 802.1x family of standards. EAP for user authentication may apply various authentication mechanisms using a smart card, Kerberos, public key encryption, and One Time Password (OTP) etc. EAP-Authentication and Key Agreement (EAP-AKA) may be based on the smart card such as universal subscriber identity module (USIM) card.

The EAP-AKA is a technology that applies the AKA mechanism suggested by 3^{rd} Generation Partnership Project (3GPP) to the EAP. More particularly, according to the EAP-AKA, a unique identification (ID) and a secret value of a user are stored in a universal mobile telecommunications system (UMTS) subscriber identity module (USIM) card mounted to the communication device. Subsequently, the authentication-related information used for authentication is generated using the secret value such that the user is authenticated only when the secret value is the same as that of an Authentication, Authorization and Accounting (AAA) server connected with the wireless network. However, some aspects of the EAP-AKA authentication procedures may present some challenges that may delay the attachment of a communication device with the network, and thus adversely impact the user experience.

### SUMMARY

Systems, methods, and apparatuses for reducing delays associated with the attachment procedure are disclosed. In accordance with the present disclosure, a UE may initiate an attachment procedure with a network over a non-access stratum (NAS) layer. In some examples, the attachment procedure may comprise authentication and key agreement (AKA) between a small cell base station and the UE. During the attachment procedure, a UE may detect a condition that may delay attachment. Based on the detection, the UE may determine whether the condition may be resolved before failure in the attachment procedure.

In some examples, if the UE determines that the condition can be resolved before attachment failure, the UE may suspend or extend a guard timer associated with the attachment procedure at the NAS layer to allow more time for the UE to complete the authentication. Conversely, if the UE determines that the condition cannot be resolved before the attachment failure, the UE may abort the attachment procedure with the network and initiate a fallback attachment procedure with the network via a different base station. In one or more examples, aborting the attachment procedure may include barring the UE from retrying to attach to the same base station and avoid wasting valuable resources.

Additionally or alternatively, aspects of the present disclosure may include computing a common security key by the EAP layer prior to completing an EAP procedure or receiving an EAP-Success message from the network. In some examples, the common security key may be transmitted from the EAP layer to the NAS layer to aid in completing the attachment procedures. Therefore, in accordance with the present disclosure, computing a common security key before the EAP procedures are completed may resolve delay issues associated with the attachment procedure.

According to a first set of illustrative embodiments, a method for wireless communications is described. In some examples, the method may include initiating, at a UE, an attachment procedure with a network over a NAS layer and detecting, at the UE, a condition of an EAP layer. The condition may be associated with the attachment procedure. In some aspects, the method may further determine whether the condition associated with the attachment procedure can be resolved before failure in the attachment procedure. The method may invoke a trigger based on the determining, wherein the trigger may identify whether to proceed with the attachment procedure at the NAS layer.

According to a second set of illustrative embodiments, an apparatus for wireless communications is described. The apparatus may comprise means for initiating, at a UE, an attachment procedure with a network over a NAS layer and means for detecting, at the UE, a condition of an EAP layer. The condition may be associated with the attachment procedure. In some aspects, the apparatus may further include means for determining whether the condition associated with the attachment procedure can be resolved before failure in the attachment procedure. The apparatus may include means for invoking a trigger based on the determining, wherein the trigger may identify whether to proceed with the attachment procedure at the NAS layer.

According to a third set of illustrative embodiments, a computer-readable medium storing code for wireless communication is disclosure. The code may comprise instructions executable by a computer to initiate, at a UE, an attachment procedure with a network over a NAS layer and detect, at the UE, a condition of an EAP layer. The condition may be associated with the attachment procedure. In some aspects, the code may further determine whether the condition associated with the attachment procedure can be resolved before failure in the attachment procedure. In one or more examples, the code may further include instructions to invoke a trigger based on the determining, wherein the trigger may identify whether to proceed with the attachment procedure at the NAS layer.

According to a fourth set of illustrative embodiments, another method for wireless communication is disclosed. The method may include initiating, at a network entity, an attachment procedure with the UE, and detecting, at the network entity, a condition associated with the attachment procedure. In some examples, the condition may delay authentication with the UE. Accordingly, the method may determine whether the condition associated with the attachment procedure may be resolved before failure in the attachment procedure. In some aspects, the method may suspend a timer at the network entity based on the determining. Suspending the timer at the network entity may allow additional time for the UE to complete the attachment procedure.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

The disclosed aspects of the present disclosure will hereinafter be described in conjunction with the appended drawings, provided to illustrate and not to limit the disclosed aspects, wherein like designations denote like elements, where a dashed line may indicate an optional component, and in which:

FIG. 1 illustrates an example of a wireless communications system for minimizing delays associated with the attachment procedure are disclosed in accordance with various aspects of the present disclosure;

FIG. 2 illustrates an example of a schematic diagram of a communication network including aspects of base station and UE in accordance with various aspects of the present disclosure

FIG. 3A illustrates a call flow diagram for minimizing delays associated with the attachment procedure by suspending or extending a guard timer are disclosed in accordance with various aspects of the present disclosure;

FIG. 3B illustrates a call flow diagram for minimizing delays associated with the attachment procedure by aborting unnecessary retries are disclosed in accordance with various aspects of the present disclosure;

FIG. 3C illustrates a call flow diagram for minimizing delays associated with the attachment procedure by computing a common security key before the EAP procedures are completed;

FIG. 4 is a diagram illustrating an example of a hardware implementation for an apparatus employing a processing system;

FIG. 5 illustrates an example of a flowchart performed by the UE that shows aspects for minimizing delays associated with the attachment procedure in accordance with various aspects of the present disclosure;

FIG. 6 illustrates an example of a flowchart performed by the network that shows aspects for minimizing delays associated with the attachment procedure in accordance with various aspects of the present disclosure; and

FIG. 7 is a diagram illustrating an example of an implementation for an apparatus employing a processing system.

### DETAILED DESCRIPTION

Various aspects are now described with reference to the drawings. In the following description, for purposes of explanation, numerous specific details are set forth to provide a thorough understanding of one or more aspects. It should be understood, however, that such aspect(s) may be practiced without these specific details.

As discussed above, some aspects of the EAP-AKA authentication procedures may present some challenges that may delay the attachment of a UE with the network. For example, as per 3GPP NAS protocol, a UE initiated NAS procedure (e.g., attachment procedure) may be guarded with a timer (e.g., guard timer). The expiration of the guard timer before an expected network response is received may signal a failure of the NAS procedure, and therefore, the UE may abort the attachment procedure prematurely. However, failure to receive the network response may be indicative of a temporary failure (e.g., synchronization failure) and additional time or attempts may resolve the temporary failure.

Alternatively, in some examples, a UE, following an authentication failure, may nonetheless retry attaching to the same cell multiple times. During the retry period, the UE may not receive any service. Only after the UE has completed multiple retry attempts would the UE attempt to fallback to another network by attempting to establish communication with a different base station or access point. However, in this case, the attachment failure may be permanent (e.g., due to authentication failure) so any additional tries to attach to the same cell may be superfluous.

Additionally or alternatively, in some aspects of the EAP-AKA authentication procedures, a race condition may delay the UE's attachment with the network. For example, in some aspects, the authentication authorization and accounting (AAA) server of the network may transmit an EAP-Success message to both the mobility management entity (MME) of the network and the UE. However, in some instances, the MME may receive the EAP-Success message before the UE receives the EAP-Success message from the AAA server. As a result, the MME may initiate security mode command (SMC) procedures that would force the UE to start SMC procedures prior to UE computing a common security key. This condition may cause the attachment procedure to fail because the UE does not have the common security key previously generated.

Aspects of the present disclosure reduce the above-identified delays associated with the attachment procedure. Specifically, in accordance with the present disclosure, a UE may initiate an attachment procedure with a network over a non-access stratum (NAS) layer. In some examples, the attachment procedure may comprise authentication and key agreement (AKA) between a small cell base station and the UE. During the attachment procedure, a UE may detect a condition that may delay attachment. Based on the detection, the UE may determine whether the condition may be resolved before failure in the attachment procedure.

In some examples, if the UE determines that the condition can be resolved before attachment failure, the UE may suspend or extend a guard timer associated with the attachment procedure at the NAS layer to allow more time for the UE to complete the authentication. Conversely, if the UE determines that the condition cannot be resolved before the attachment failure, the UE may abort the attachment procedure with the network and initiate a fallback attachment procedure with the network via a different base station. In one or more examples, aborting the attachment procedure may include barring the UE from retrying to attach to the same base station and avoid wasting valuable resources.

Additionally or alternatively, aspects of the present disclosure may include computing a common security key by the EAP layer prior to completing an EAP procedure or receiving an EAP-Success message from the network. In some examples, the common security key may be transmitted from the EAP to the NAS layer to aid in completing attachment. Therefore, in accordance with the present disclosure, computing a common security key before the EAP procedures are completed may resolve delay issues associated with the attachment procedure.

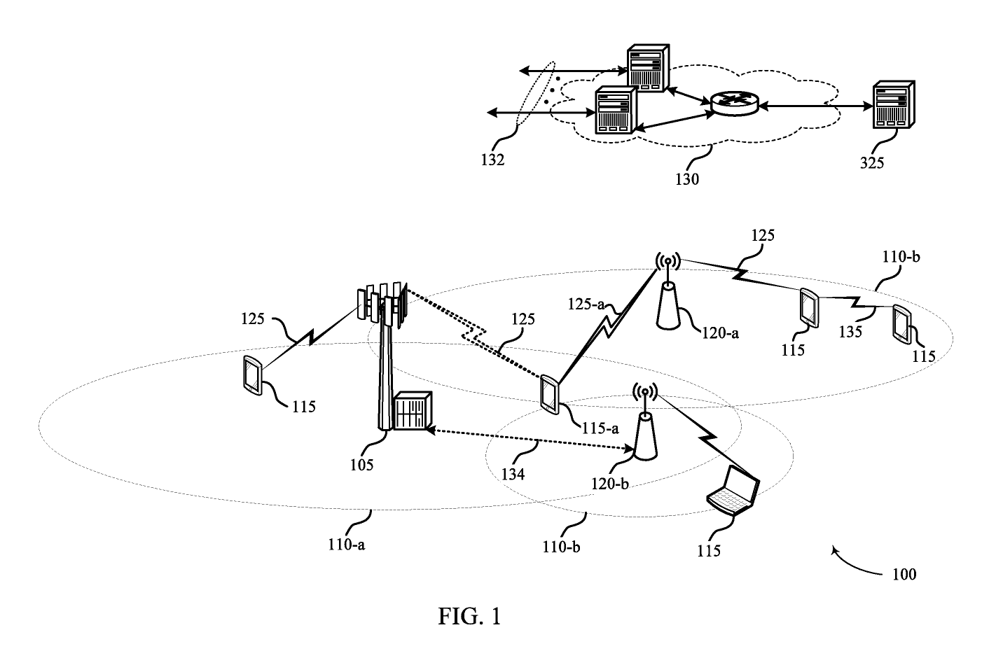

FIG. 1 illustrates an example of a wireless communications system for minimizing delays associated with the attachment procedure in accordance with various aspects of the present disclosure. The system 100 includes base stations 105, small cell access points (AP) 120, mobile devices 115, and a core network 130. In some aspects of the present disclosure, the base station 105 may be referred to as a macro cell base station, and AP 120 may be referred to as small cell base station. The core network 130 may provide user authentication, access authorization, tracking, internet protocol (IP) connectivity, and other access, routing, or mobility functions. The base stations 105 may interface with the core network 130 through communication links 132 (e.g., S1, etc.). The base stations 105 and AP 120 may perform radio configuration and scheduling for communication with the mobile devices 115, or may operate under the control of a base station controller (not shown). In various examples, the base station 105 and AP 120 may communicate, either directly or indirectly (e.g., through core network 130), with each other over backhaul links 134 (e.g., X2, Over-the-air (OTA) etc.), which may be wired or wireless communication links. In some aspects of the present disclosure, the base station 105 and AP 120 may share their respective timing parameters associated with communication scheduling.

The base station 105 and AP 120 may wirelessly communicate with the mobile device 115 via one or more antennas. Each of the base station 105 and AP 120 may provide communication coverage for a respective geographic coverage area 110. In some examples, base station 105 may be referred to as a base transceiver station, a radio base station, an access point, a radio transceiver, a NodeB, eNodeB (eNB), Home NodeB, a Home eNodeB, or some other suitable terminology. The geographic coverage area 110-a for a base station 105 and coverage area 110-b for AP 120 may be divided into sectors making up only a portion of the coverage area (not shown). The wireless communications system 100 may include base station 105 and AP 120 of different types (e.g., macro or small cell base stations). There may be overlapping geographic coverage areas 110 for different technologies.

While the mobile devices 115 may communicate with each other through the base station 105 and AP 120 using communication links 125, each mobile device 115 may also communicate directly with one or more other mobile devices 115 via a direct wireless link 135. Two or more mobile devices 115 may communicate via a direct wireless link 135 when both mobile devices 115 are in the geographic coverage area 110 or when one or more mobile devices 115 are within the AP geographic coverage area 110-b. Examples of direct wireless link 135 may include Wi-Fi Direct connections, connections established using a Wi-Fi Tunneled Direct Link Setup (TDLS) link, and other P2P group connections. In other implementations, other peer-to-peer connections or ad hoc networks may be implemented within the system 100.

In some examples, the wireless communications system 100 includes a wireless wide area network (WWAN) such as an LTE/LTE-Advanced (LTE-A) network. In LTE/LTE-A networks, the term evolved node B (eNB) may be generally used to describe the base stations 105, while the term user equipment (UEs) may be generally used to describe the mobile devices 115. The wireless communications system 100 may include a heterogeneous LTE/LTE-A network in which different types of eNBs provide coverage for various geographical regions. The wireless communications system 100 may, in some examples, also support a wireless local area network (WLAN). A WLAN may be a network employing techniques based on the Institute of Electrical and Electronics Engineers (IEEE) 802.11x family of standards (“Wi-Fi”). In some examples, each eNB or base station 105 and AP 120 may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

A macro cell generally covers a relatively large geographic area (e.g., several kilometers in radius) and may allow unrestricted access by mobile device 115 with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by mobile device 115 with service subscriptions with the network provider. A femto cell may also cover a small geographic area (e.g., a home) and may provide restricted access by mobile device 115 having an association with the femto cell (e.g., mobile device 115 in a closed subscriber group (CSG), mobile device 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). In some aspects of the present disclosure, the base station 105 may be referred to as a macro cell base station, and AP 120 may be referred to as small cell base station.

The wireless communications system 100 may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or packet data convergence protocol (PDCP) layer may be IP-based. A radio link control (RLC) layer may perform packet segmentation and reassembly to communicate over logical channels. A medium access control (MAC) layer may perform priority handling and multiplexing of logical channels into transport channels. The MAC layer may also use hybrid automatic repeat request (HARQ) to provide retransmission at the MAC layer to improve link efficiency. In the control plane, the radio resource control (RRC) protocol layer may provide establishment, configuration, and maintenance of an RRC connection between a mobile device 115 and the base stations 105. The RRC protocol layer may also be used for core network 130 support of radio bearers for the user plane data. At the physical (PHY) layer, the transport channels may be mapped to physical channels.

The mobile devices 115 may be dispersed throughout the wireless communications system 100, and each mobile device 115 may be stationary or mobile. A mobile device 115 may also include or be referred to by those skilled in the art as a user equipment (UE), mobile station, a subscriber station, STA, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A mobile device 115 may be a cellular phone, a personal digital assistant (PDA), a wireless modem, a wireless communication device, a handheld device, a tablet computer, a laptop computer, a cordless phone, a wireless local loop (WLL) station, or the like. A mobile device may be able to communicate with various types of base stations and network equipment including macro eNBs, small cell eNBs, relay base stations, and the like. In some examples, a dual-radio UE 115-a, may include a WLAN radio (not shown) and a WWAN radio (not shown) that may be configured to concurrently communicate with base station 105 (using the WWAN radio) and with AP 120 (using the WLAN radio).

The communication links 125 shown in wireless communications system 100 may include uplink (UL) transmissions from a mobile device 115 to a base station 105 or AP 120, or downlink (DL) transmissions, from a base station 105 or AP 120 to a mobile device 115. The downlink transmissions may also be called forward link transmissions while the uplink transmissions may also be called reverse link transmissions. Each communication links 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2).

The communication links 125 may utilize resources of licensed spectrum or unlicensed spectrum, or both. Broadly speaking, the unlicensed spectrum in some jurisdictions may range from 600 Megahertz (MHz) to 6 Gigahertz (GHz), but need not be limited to that range. As used herein, the term “unlicensed spectrum” or “shared spectrum” may thus refer to industrial, scientific and medical (ISM) radio bands, irrespective of the frequency of those bands. An “unlicensed spectrum” or “shared spectrum” may refer to a spectrum used in a contention-based communications system. In some examples, unlicensed spectrum is the U-NII radio band, which may also be referred to as the 5 GHz or 5G band. By contrast, the term “licensed spectrum” or “cellular spectrum” may be used herein to refer to wireless spectrum utilized by wireless network operators under administrative license from a governing agency.

Wireless communications system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A mobile device 115 may be configured with multiple downlink CCs and one or more uplink CCs for carrier aggregation. Carrier aggregation may be used with both FDD and TDD component carriers.

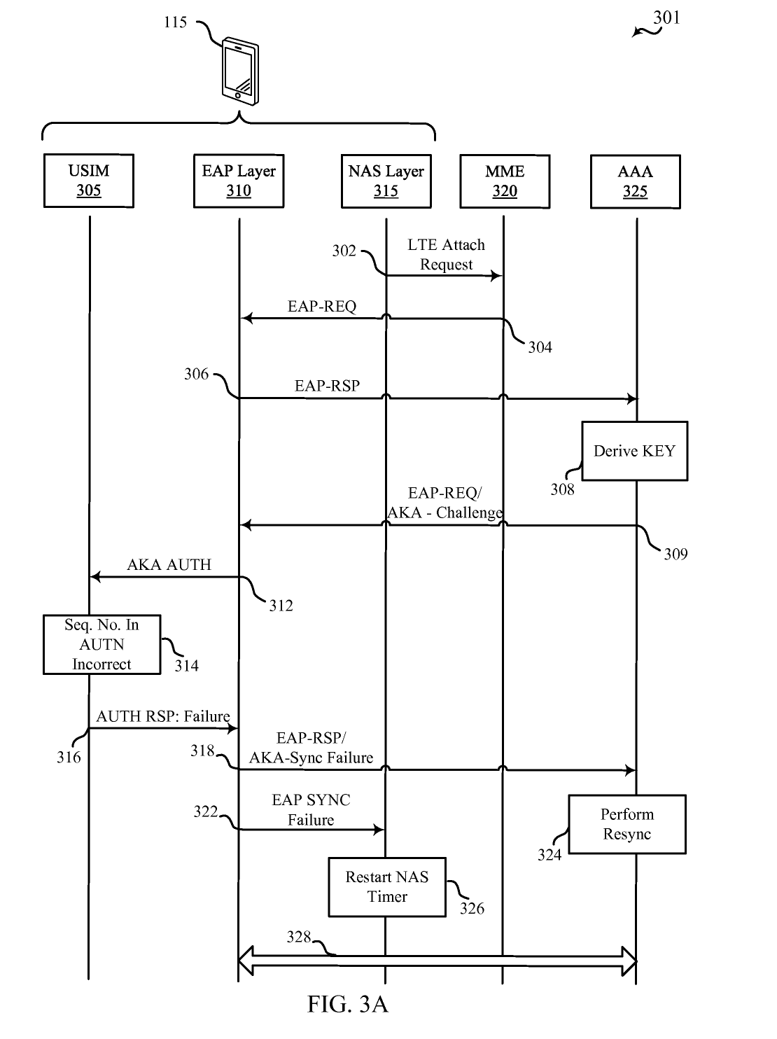

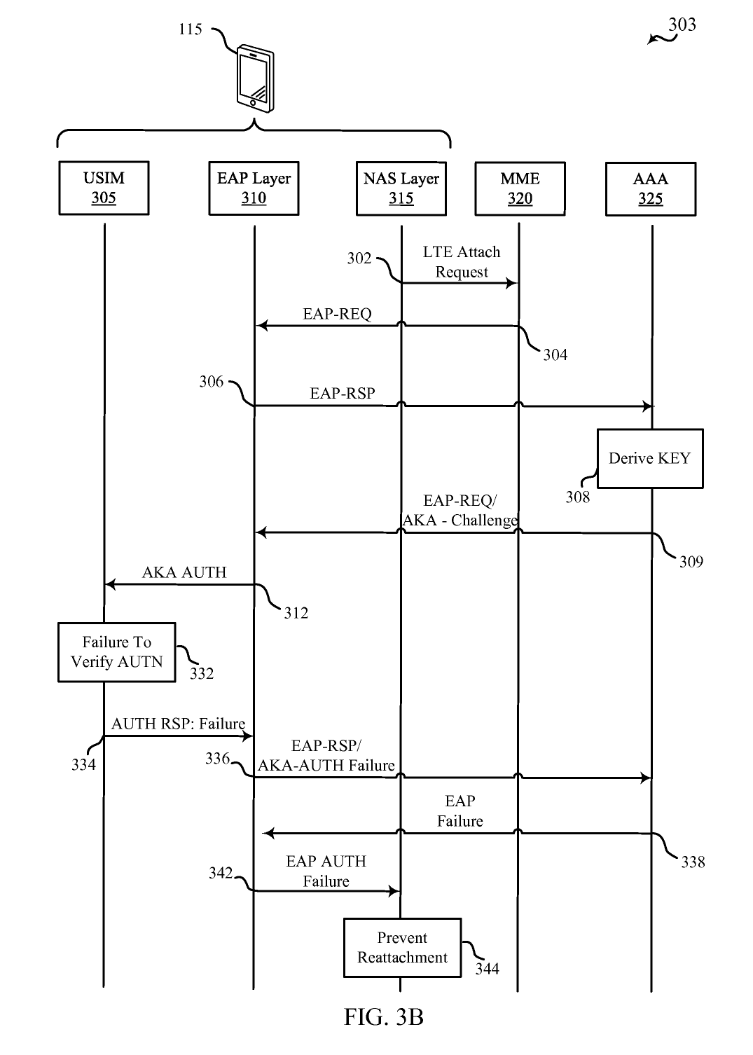

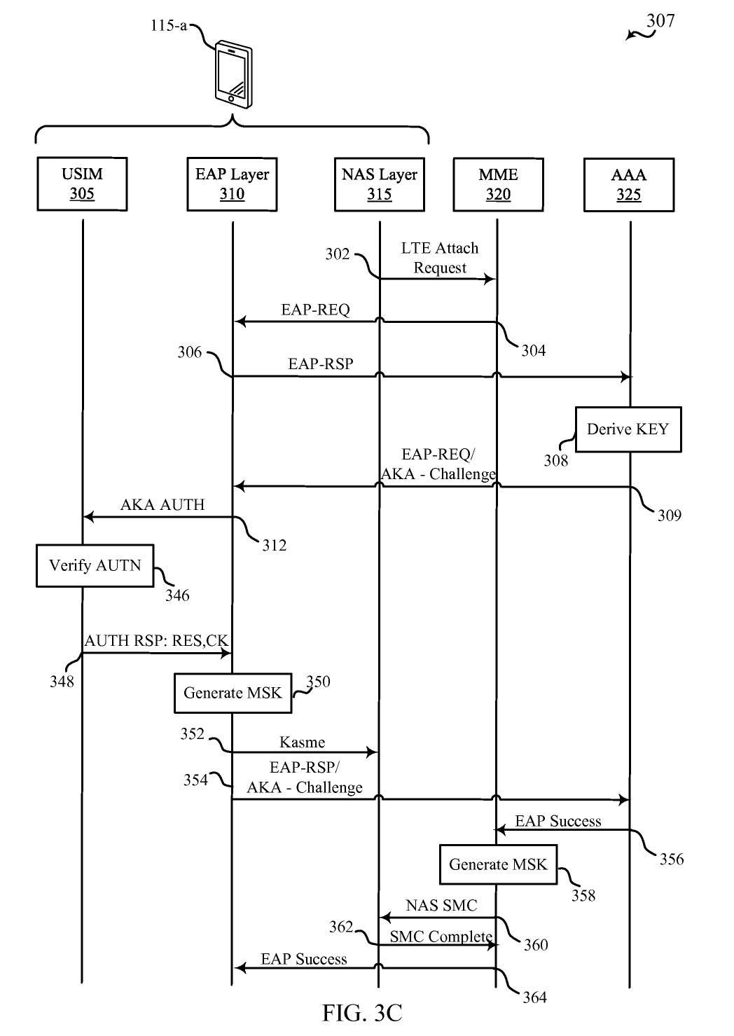

In some aspects of the present disclosure, a UE 115-a may initiate an attachment procedure with the network 130 via small cell AP 120-a. The term “attaching” or “attachment procedure” may refer to a method of authenticating and establishing communication with one or more base stations (e.g., base station 105 and/or AP 120). Accordingly, when a UE 115-a initiates an attachment procedure with the network 130 via a small cell AP 120-a, the network 130 may require authentication through an AAA server 325 (see FIGS. 3A-3C) at the network.

In some aspects, an EAP-AKA protocol may be employed for authenticating subscribers using universal mobile telecommunications system (UMTS) subscriber identity module (USIM) that wish to connect to the network 130. EAP-AKA may require an AAA server 325 to retrieve key material from a home location register/home subscriber server (HLR/HSS). It should be appreciated that aspects of the authentication, authorization and accounting functions may be split between two or more servers. For example, the HLR may store the subscriber credentials and profiles that may be used by the AAA server 325 to perform AAA functions.

Thus, in some examples, when the UE 115-a initiates an attachment procedure with the network 130, the credential validation may involve extensible authentication protocol (EAP). EAP may be a protocol for transmitting user authentication data based on Institute of Electrical and Electronics Engineers (IEEE) 802.1x family of standards. As noted above, some aspects of the EAP and authentication procedures may involve delays that may be minimized by implementing one or more methods described in accordance with the present disclosure.

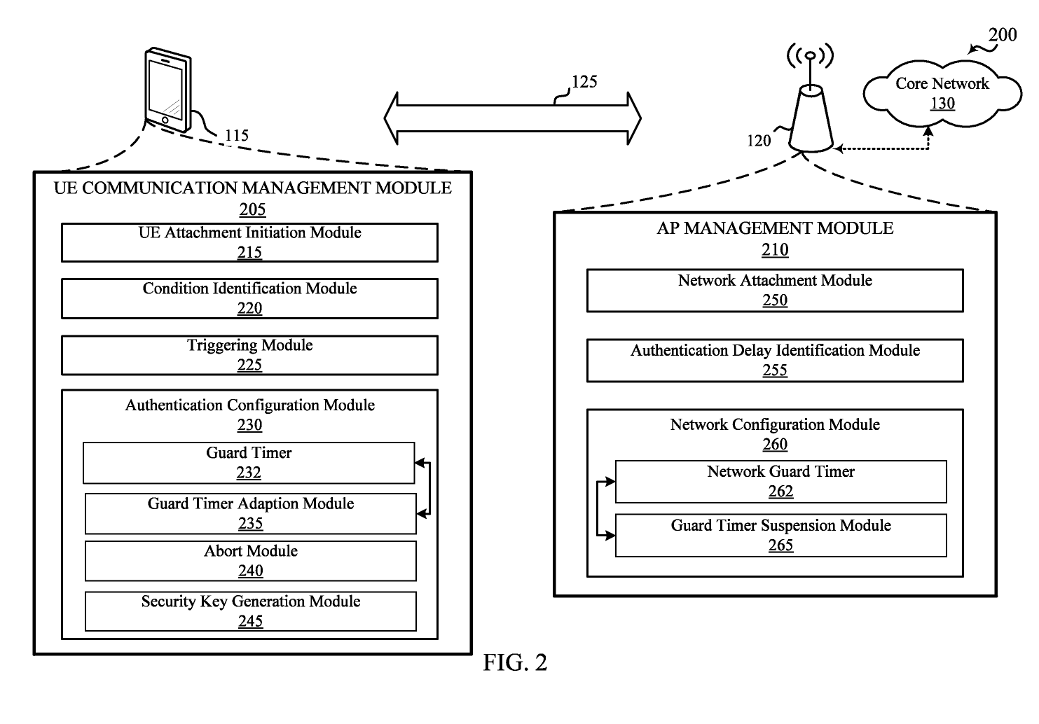

For example, with respect to issues related to expiration of a guard timer 232 (see FIG. 2) that may result in a premature abortion of the attachment procedures, aspects of the present disclosure provide a method for the UE 115-a to detect a condition (e.g., synchronization issues with the network) and determine that the condition associated with the attachment procedure may be resolved before failure in the attachment procedure. Specifically, the EAP layer (e.g., EAP layer 310 in FIGS. 3A-3C) of the UE 115-a may detect that the delay in authentication may be associated with, for example, a synchronization failure, and not a permanent authentication failure. As a result, the EAP layer of the UE 115-a may generate a notification for the non-access stratum (NAS) layer (e.g., NAS layer 315 of FIGS. 3A-3C) of the UE 115-a to either suspend or extend (i.e., add time) the guard timer 232 associated with the NAS attachment procedures. Suspending or extending the guard timer 232 at the NAS layer may be based on a determination of an estimated time that the EAP layer anticipates would be required for the synchronization failure to be resolved.

In some examples, a corresponding network guard timer 262 (see FIG. 2) at the network entity (e.g., core network 130 or AP 120) may also be suspended or extended. In such instance, the network entity may mirror the procedures of the UE 115-a based on prearranged coordinated procedures. Therefore, due to the notification from the EAP layer to the NAS layer of the UE 115-a to suspend or extend the guard timer 232, the NAS layer may be prevented from prematurely aborting the attachment procedures based on a determination that the condition would be resolved before failure in the attachment procedure. However, in some cases, aspects of the present disclosure may allow the timer to expire. In such instances, the attachment failure may be resolved by the UE internally to enable the UE 115-a to attach to the network.

Additionally or alternatively, with respect to the scenario where the UE 115-a may detect that the UE has failed to authenticate with the small cell AP 120-a (e.g., due to incorrect security credentials), aspects of the present disclosure may allow the UE 115-a to determine that no amount of retries or time delays may resolve the authentication issues. Accordingly, the EAP layer of the UE 115-a may transmit a notification to the NAS layer of the UE 115-a to abort the attachment procedure with the AP 120-a and bar the NAS layer of the UE 115-a from retrying to attach to the same small cell (e.g., AP 120-a). Instead, in some examples, the NAS layer of the UE 115-a, upon receiving the notification from the EAP layer, may initiate fallback attachment procedure with the network 130 via a different base station over the NAS layer. In some examples, a different base station may be another small cell AP 120-b or a macro cell base station 105.

In yet further examples, the delays in attachment procedure may be related to a race condition. For example, the AAA server 325 (also see FIG. 3A-3C) of the network 130 may transmit an EAP-Success message to both the mobility management entity (MME) server and the UE 115-a. However, a race condition may develop when the MME server receives the EAP-Success message before the UE 115-a receives the EAP-Success message from the AAA server 325. As a result, the MME server may initiate security mode command (SMC) procedures that may force the UE 115-a to start SMC procedures before the UE 115-a is able to compute a common security key (e.g., K_{ASME}). Such a condition would generally cause the attachment procedure to fail because the UE 115-a may not have generated the common security key at that time.

Accordingly, in some aspects of the present disclosure, the EAP layer of the UE 115-a may compute the common security key and transmit the common security key to the NAS layer before the UE 115-a completes the EAP procedures or receives the EAP-success message from the AP 120-a. In this example, the UE 115-a, in accordance with the present disclosure, may take an optimistic approach and assume that the authentication of the UE 115-a by the network 130 via AP 120-a may eventually succeed. Thus, generating the common security key prior to completing the EAP procedures may prevent attachment failures due to the development of the race condition.

FIG. 2 illustrates a system 200 in which a UE 115 may establish communication with the network 130 via a small cell AP 120. System 200 may illustrate, for example, aspects of wireless communications system 100 illustrated in FIG. 1. In the example of FIG. 2, a small cell AP 120 may communicate with one or more UEs 115 within the coverage area 110-b of the small cell AP 120.

In some aspects, the UE 115 may include a UE communication management module 205. The UE communication management module 205 may include a UE attachment initiation module 215 for initiating an attachment procedure with the network 130 over a non-access stratum (NAS) layer. In some examples, the attachment procedure may include EAP-AKA between the UE 115 and the small cell AP 120. The UE communication management module 205 may further include a condition identification module 220 for detecting, at the EAP layer of the UE 115, a condition associated with the attachment procedure. In some examples, the condition may refer to one or more attachment delay scenarios (e.g., expiration of guard timer 232, unnecessary retries and/or race condition) described above. Accordingly, the condition identification module 220 may determine whether the condition associated with the attachment procedure can be resolved before failure in the attachment procedure. In some examples, the condition identification module 220 may determine to proceed with the attachment procedure at the NAS layer based on the determining that the condition can be resolved before failure in the attachment procedure.

Additionally or alternatively, the UE communication management module 205 may include a triggering module 225 for invoking a trigger based on determining whether the condition associated with the attachment procedure can be resolved before failure in the attachment procedure. In yet further examples, the UE communication management module 205 may also include an authentication configuration module 230 for determining whether to proceed with the attachment procedure at the NAS layer based on the trigger. In some instances, determining whether to proceed may be determinative based on whether the condition associated with the attachment procedure can be resolved.

If the authentication configuration module 230 determines that the condition associated with the attachment procedure can be resolved before failure in the attachment procedure, the guard timer adaption module 235 may suspend a guard timer 232 associated with the attachment procedure at the NAS layer. In some examples, suspending the guard timer 232 may comprise identifying a length of time period that the guard timer 232 is to remain suspended. Additionally or alternatively, the guard timer adaption module 235 may extend the guard timer 232 by adding additional time on the guard timer 232 based on determining that the condition can be resolved. In some aspects, a corresponding network guard timer 262 at the AP 120 and/or network 130 may also be suspended or extended to mirror the procedures adopted by the guard timer adaption module 235.

In other examples, the authentication configuration module 230 may include an abort module 240 for aborting the attachment procedure with the small cell AP 120 based on determine that the condition associated with the attachment procedure cannot be resolved. In some aspects, the abort module 240 may include transmitting a notification from the EAP layer to the NAS layer to request that the UE 115 abort its attachment procedures. In further examples, the abort module 240 may also include initiating a fallback attachment procedure with the network 130 via a different base station (e.g., macro base station 105 or second AP 120).

Additionally or alternatively, the authentication configuration module 230 may include a security key generation module 245 for computing a common security key prior to completing an EAP procedures or receiving an EAP-Success message from the small cell AP 120. In some aspects, the security key generation module 245 may comprise generating the common security key at the EAP layer and transmitting the generated key to the NAS layer of the UE 115.

In other examples of the present disclosure, the small cell AP 120 may include an AP management module 210 for managing attachment and authentication procedures at the network. It should be understood by those of ordinary skill in the art that some aspects described with reference to the small cell AP 120 may be split between the core network 130 and the AP 120. Accordingly, the AP management module 210 may include a network attachment module 250 for initiating (or responding) to an attachment procedure with the UE 115. In some examples, the attachment procedures may include an EAP-AKA between the UE 115 and the AP 120.

In yet further examples, the AP management module 210 may include an authentication delay identification module 255 for detecting, at the network entity, a condition associated with the attachment procedure where the condition delays authentication with the UE 115. Accordingly, a network configuration module 260 may determine whether the condition associated with the attachment procedure can be resolved and employing a guard timer suspension module 265 for suspending a network guard timer 262 at the network entity based on determining that the condition can be resolved.

In some examples, the guard timer suspension module 265 may identify a period of time to extend the network guard timer 262 based on anticipated delays in completing authentication with the UE 115 and extending the timer at the network entity for the designated period of time. In one or more examples, suspending the network guard timer 262 at the network entity may be based on a predetermined configuration parameter established with the UE 115.

FIGS. 3A-3C illustrates call flow diagrams of initially attaching a UE 115 to an EPS network via an E-UTRAN, and using an EAP authentication for an authentication by an AAA server 325. In some aspects, a UE 115 may include USIM 305, an EAP layer 310, and NAS layer 315. The UE 115 may be an example of UE 115 described with reference to FIGS. 1 and 2. Additionally or alternatively, a network entity (e.g., base station 105, small cell AP 120 and/or core network 130) may include MME server 320 and AAA server 325 and HSS (not shown). It should be appreciated by those skilled in the art that functionalities of the MME server 320, AAA server 325 and/or HSS may be split between the base station 105, small cell AP 120, and/or a core network 130 described with reference to FIG. 1.

Turning first to FIG. 3A, a call flow diagram 301 illustrates an example of minimizing delays associated with the attachment procedure by suspending or extending a guard timer. At 302, the UE 115 may initiate an LTE attachment procedure with a network over a NAS layer 315. At 304, the MME server 320 may transmit an EAP request (EAP-REQ) to the EAP layer 310 of the UE 115 in response to the initiation of the attachment procedures. In some examples, the MME server 320 may be responsible for control plane related functionalities, such as mobility management, non-access stratum signal processing and management of the user mobile management context.

At 306, the EAP layer 310 of the UE 115 may transmit an EAP response (EAP-RSP) message to the AAA server 325 of the network. In some examples, the EAP-RSP message may include EAP authentication information required for the EAP authentication. For example, the EAP authentication information may include a subscriber identity (e.g., international mobile subscriber identity (IMSI) or temporary identity) to identify the UE 115. After obtaining the subscriber identity, the network may obtain authentication vector for use in authenticating the subscriber (not shown). The authentication vectors may be a concatenation of random number part (RAND), an authentication token (AUTN), an expected result (XRES), a session key for encryption (CK), and a session key for integrity check (ID). In some examples, the authentication vectors may be obtained by contacting the HSS (not shown) at the network. As a result, at block 308, the AAA server 325 may derive an authentication key.

Next, at 309, the AAA server 325 may initiate the AKA protocol by sending an EAP-Request/AKA-Challenge message to the EAP layer 310 of the UE 115. The EAP-Request/AKA-Challenge message may include a RAND random number, a network authentication token, and a message authentication code. Based on receiving the EAP-Request/AKA-Challenge message, the UE 115, at 312, may verify the AUTN and retrieve a sequence number associated with the authentication challenge. Specifically, the USIM 305, at 314, may verify whether the received sequence number SQN is within a correct range established by the network in order to verify that the authentication vector is “fresh”, or previously unused. In some examples, the network may maintain the fresh sequence number range for each subscriber across authentication exchanges, and the UE 115 may verify that each authentication vector has a previously unused sequence number.

If the USIM 305, at 314, determines that the SQN is not in the correct range, for example because the SQN is smaller than the greatest number used so far, the UE 115, at 316 may send a synchronization failure to the EAP layer 310. Additionally or alternatively, the EAP layer 310, at 318, may transmit an EAP-RSP/AKA-Synchronization failure message back to the AAA server 325. In such instances, at block 324, a resynchronization procedure is started when the UE 115 calculates a sequence number synchronization parameter AUTS and transmits to the AAA server 325 in order to inform the network the expected range of the current sequence number SQN. Accordingly, the network and the UE 115 may reinitiate the authentication procedures.

However, as discussed above, a UE 115 initiated attachment procedure may be guarded with a timer. Hence, although additional attempts to authenticate may result in eventual success, an expiration of the timer may cause the UE 115 to prematurely abort the attachment procedure.

Thus, aspects of the present disclosure allow the EAP layer 310 of the UE 115 to detect that a condition associated with the attachment procedure causing authentication delays can be resolved before failure in the attachment procedure. Accordingly, the EAP layer 310 of the UE 115, at 322, may generate a notification (e.g., EAP-SYNC failure message) and transmit the notification to the NAS layer 315. In some examples, the notification may include invoking a trigger to request the NAS layer 315, at block 326, to suspend or extend a timer associated with the attachment procedure. In some examples, suspending and/or extending the timer may be based on a determination of an approximate time the EAP layer 310 anticipates would take for the synchronization failure to be resolved. In some aspects, a corresponding timer at the network (not shown) may also be suspended or extended. In such instance, the network may mirror the procedures of the UE based on a predetermined coordinated procedures.

Therefore, due to the notification to suspend or extend the timer, the NAS layer 315 may be prevented from prematurely aborting the attachment procedure. In some examples, at 328, the UE 115 and the network may subsequently resolve the synchronization issues and may successfully complete the attachment procedures.

In contrast, FIG. 3B illustrates a call flow diagram 303 for minimizing delays associated with the attachment procedure by aborting unnecessary retries are disclosed in accordance with various aspects of the present disclosure. In some examples, steps 302-312 may be identical to those described with reference to FIG. 3A. However, in contrast to the synchronization failure in FIG. 3A, which can be a condition that could be resolved before failure in the attachment procedure, the USIM 305 of the UE 115, at 332, may detect an authentication failure. For example, even if the SQN is verified, the UE 115 may fail to properly authenticate with the network due to one or more authentication parameters not correlating with the network. As a result, the USIM 305, at 334, may transmit an authentication response message to the EAP layer 310 identifying the authentication failure. Thus, the EAP layer 310, at 336, may respond with the EAP-Response/AKA-Authentication Failure message to the AAA server 325. The AAA server 325, in response, at 338 may issue an EAP failure message to the UE 115.

In accordance with the present disclosure, the EAP layer 310 may detect that the authentication failure condition may not be resolvable despite any number of reattempts. As a result, the EAP layer 310, at 342, may generate and issue a notification to the NAS layer 315 to request the NAS layer 315 to abort the attachment procedure and bar the NAS layer 315 from additional retries to attach to the same cell. Accordingly, the NAS layer 315 may avoid wasting valuable time, and fallback to a different network (e.g., macro-network or another small cell).

In yet further example, FIG. 3C illustrates a call flow diagram 307 for minimizing delays associated with the attachment procedure by computing a common security key before the EAP procedures are completed. In some examples, steps 302-312 may be identical to those described with reference to FIGS. 3A and 3B. However, at 346, the USIM 305 may verify that the UE 115 is communicating with a legitimate network and proceed to issue an authentication response at 348 to the EAP layer 310. Based on receiving the authentication response, the EAP layer 310, in accordance with aspects of the present disclosure, may compute a common security key at block 350 prior to completing an EAP procedure or receiving an EAP-Success message (see 364) from the network.

At 352, the EAP layer 310 may transmit the common security key to the NAS layer 315. Additionally or alternatively, the EAP layer 310, at 354, may transmit an EAP-Response/AKA-Challenge message back to the AAA server 325 to indicate AUTN verification. In response, at 356, the AAA server 325 may transmit an EAP success message to the MME server 320. As a result, the MME server 320, at block 358, may generate common security key to compare with the security key generated by the UE 115. Additionally or alternatively, the MME server 320, at 360, may initiate security mode command (SMC) procedures that would force the UE to start and complete SMC at 362. However, because the EAP layer 310 had previously computed the common security key at block 350, the UE 115 may avoid a condition where the attachment procedures may fail because the UE 115 does not have the common security key generated at the time of initiating SMC procedures. Therefore, at 364, the MME server 320 may transmit an EAP success message to the network and subsequently establish communication between the network and the UE 115.

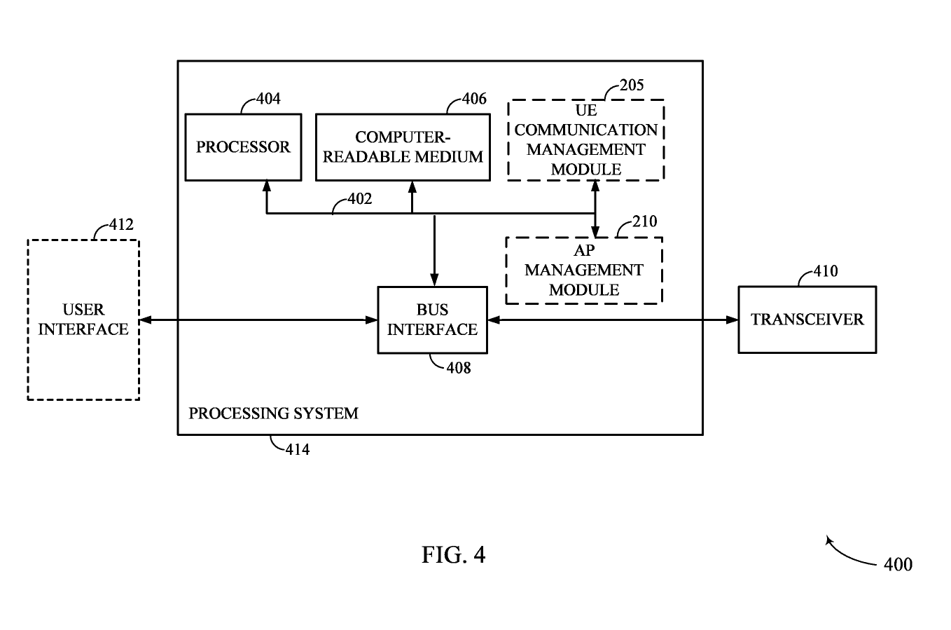

FIG. 4 is a conceptual diagram illustrating an example of a hardware implementation for an apparatus 400 employing a processing system 414. In some examples, the processing system 414 may be an example of a UE 115 or small cell AP 120 described with reference to FIGS. 1-3C. In this example, the processing system 414 may be implemented with a bus architecture, represented generally by the bus 402. The bus 402 may include any number of interconnecting buses and bridges depending on the specific application of the processing system 414 and the overall design constraints. The bus 402 links together various circuits including one or more processors, represented generally by the processor 404, computer-readable media, represented generally by the computer-readable medium 406, a UE communication management module 205 (see FIG. 2) and/or AP management module 210 (see FIG. 2), which may be configured to carry out one or more methods or procedures described herein.

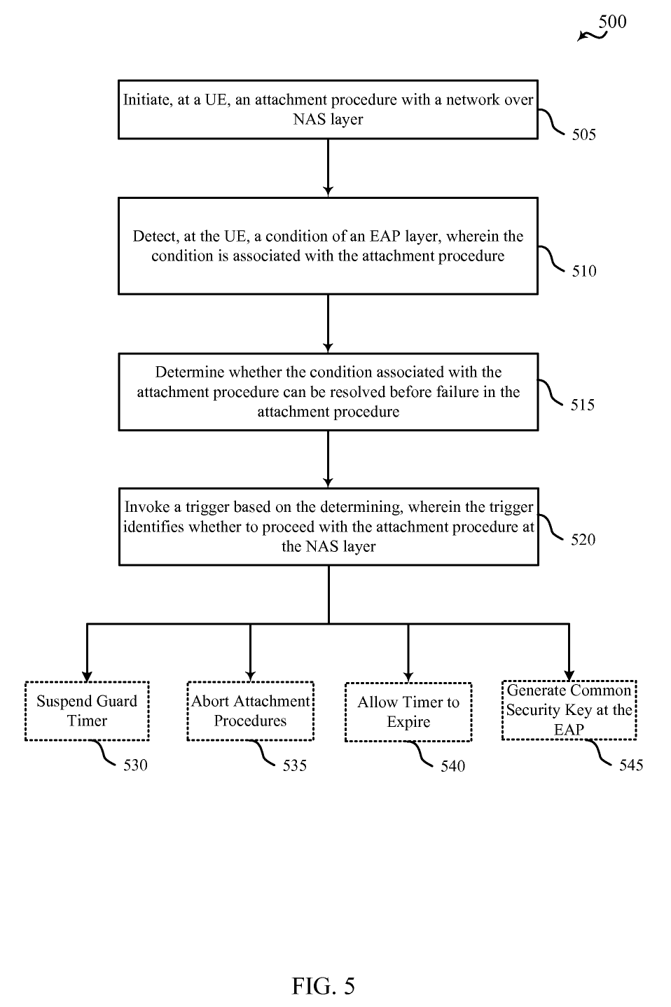

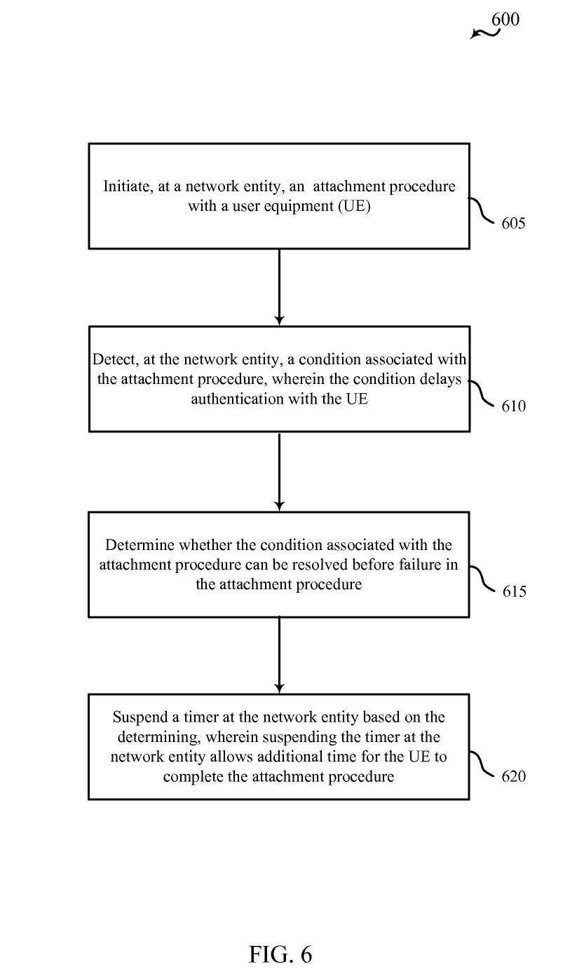

In some instances, a UE communication management module 205 may be implemented when processing system 414 is used in a UE 115. Conversely, an AP management module 210 may be implemented when the processing system 414 is used in an AP 120. In an aspect, UE communication management module 205, AP management module 210 and the components therein may comprise hardware, software, or a combination of hardware and software that may be configured to perform the functions, methodologies (e.g., method 500 of FIG. 5 and method 600 of FIG. 6), or methods presented in the present disclosure.

The bus 402 may also link various other circuits such as timing sources, peripherals, voltage regulators and power management circuits, which are well known in the art, and therefore, will not be described any further. A bus interface 408 provides an interface between the bus 402 and a transceiver 410. The transceiver 410 provides a means for communicating with various other apparatus over a transmission medium. Depending upon the nature of the apparatus, a user interface 412 (e.g., keypad, display, speaker, microphone, joystick) may also be provided.

The processor 404 is responsible for managing the bus 402 and general processing, including the execution of software stored on the computer-readable medium 406. The software, when executed by the processor 404, causes the processing system 414 to perform the various functions described infra for any particular apparatus. The computer-readable medium 406 may also be used for storing data that is manipulated by the processor 404 when executing software. In some aspects, at least a portion of the functions, methodologies, or methods associated with the communication management module 405 may be performed or implemented by the processor 404 and/or the computer-readable medium 406.

In some examples, the computer-readable medium 406 may store code for wireless communications. The code may comprise instructions executable by a computer (e.g., processor 404) to initiate, at a UE 115, an attachment procedure with a network over a NAS protocol layer (e.g., NAS layer 315). The computer-readable medium 406 may include code for detecting, at the UE 115, a condition of an EAP layer (e.g., EAP layer 310). The condition may be associated with the attachment procedure. In some aspects, the code may determine whether the condition associated with the attachment procedure can be resolved before failure in the attachment procedure and invoke a trigger based on the determining. The trigger may identify whether to proceed with the attachment procedure at the NAS layer.

Alternatively, if the processing system 414 is configured as an AP 120, the AP management module 210 and/or computer-readable medium 406 may store code for wireless communications. The code may comprise instructions executable by a computer (e.g., processor 404) for initiating, at a network entity, an attachment procedure with UE 115. The code may further comprise detecting, at the network entity, a condition associated with the attachment procedure. The condition may delay authentication with the UE 115. In further examples, the computer-readable medium 406 may further include determining whether the condition associated with the attachment procedure can be resolved before failure in the attachment procedure. If the condition can be resolved before failure in the attachment procedure, the instructions may suspend a timer at the network entity. Suspending the timer at the network entity may allow additional time for the UE 115 and the network entity to complete the attachment procedure.

FIG. 5 is a flowchart conceptually illustrating an example of a method 500 of wireless communication, in accordance with aspects of the present disclosure. For clarity, the method 500 is described below with reference to ones of the UEs 115, described with reference to FIGS. 1-3.

In some examples, a UE 115, at block 505, may initiate an attachment procedure with a network over NAS layer. In some example, the attachment procedure may comprise EA-AKA authentication procedures. Aspects of block 505 may be performed by UE attachment initiation module 215 described with reference to FIG. 2.

At block 510, the UE 115 may detect a condition of an EAP layer where the condition is associated with the attachment procedure. Additionally, at block 515, the UE 115 may determine whether the condition associated with the attachment procedure can be resolved before failure in the attachment procedure. Aspects of blocks 510 and 515 may be performed by condition identification module 220 described with reference to FIG. 2.

At block 520, the UE 115 may invoke a trigger based on determining whether the condition associated with the attachment procedure can be resolved before failure in the attachment procedure. In some examples, the trigger may identify whether to proceed with the attachment procedure at the NAS layer. Aspects of the block 520 may be performed by triggering module 225 described with reference to FIG. 2.

In some aspects, determining whether to proceed with the attachment procedure may include suspending, at block 530, a timer associated with the attachment procedure at the NAS layer in response to determining that the condition can be resolved before failure in the attachment procedure. Additionally or alternatively, determining whether to proceed with the attachment procedure may further include aborting, at block 535, the attachment procedure with the network at the NAS layer in response to determining that the condition associated with the attachment cannot be resolved. Aspects of block 535 may be performed by abort module 240 described with reference to FIG. 2. In yet other examples, determining whether to proceed with the attachment procedure may further include allowing, at block 540, the timer to expire and allowing the UE 115 to resolve attachment procedures internally. Aspects of block 540 may also be performed by abort module 240 described with reference to FIG. 2

In yet further examples, determining whether to proceed with the attachment procedure may further include computing, at block 545, a common security key prior to completing EAP procedures or receiving an EAP-Success message from the base station. In some examples, the common security key may be generated by an EAP layer of the UE 115 and transmitted to the NAS layer of the UE 115 to be utilized for authentication procedures with the network. Aspects of block 545 may be performed by security key generation module 245 described with reference to FIG. 2.

FIG. 6 is a flowchart conceptually illustrating an example of a method 600 of wireless communication, in accordance with aspects of the present disclosure. For clarity, the method 600 is described below with reference to a network entity (e.g., base station 105, small cell AP 120 and/or core network 130) described with reference to FIGS. 1-3.

At block 605, a network entity may initiate an attachment procedure with a UE 115. Aspects of block 605 may be performed by network attachment module 250 described with reference to FIG. 2.

At block 610, the network entity may detect a condition associated with the attachment procedure where the condition delays authentication with the UE 115. Aspects of the block 610 may be performed by authentication delay identification module 255 described with reference to FIG. 2.

At block 615, the network entity may determine whether the condition associated with the attachment procedure can be resolved. Aspects of the block 610 may be performed by authentication delay identification module 255 described with reference to FIG. 2.

At block 620, the network entity may suspend a timer based on determining that the condition associated with the attachment procedure cannot be resolved. In some aspects, suspending the timer at the network entity may allow additional time for the UE to complete the attachment procedure. Aspects of block 615 may be performed by network configuration module 260 described with reference to FIG. 2.

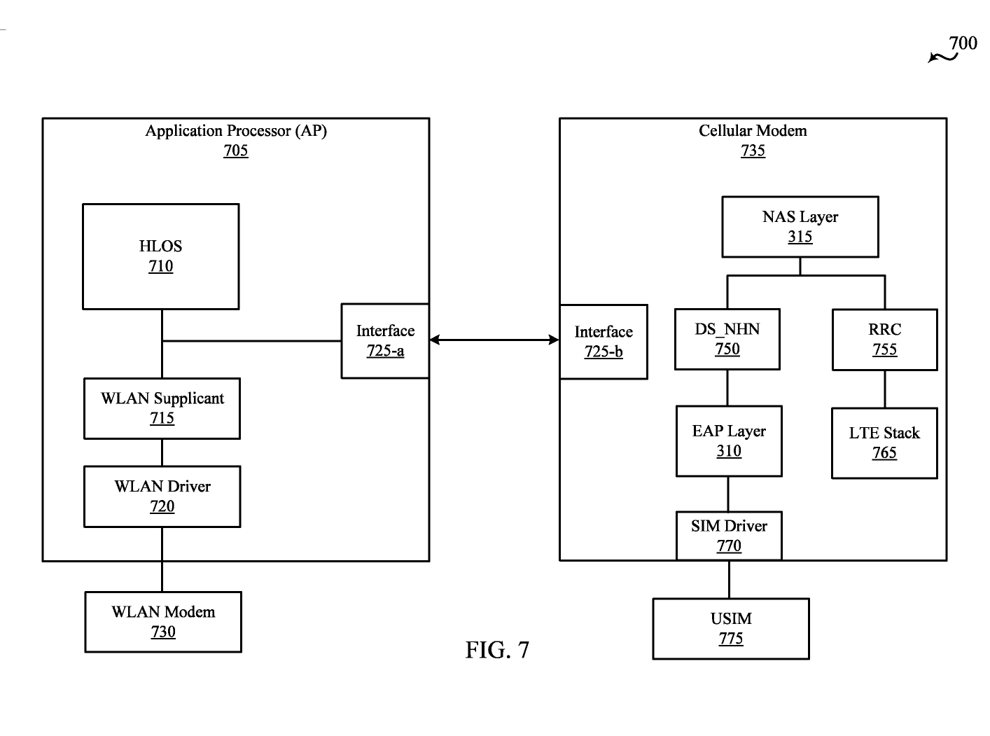

FIG. 7 illustrates a system 700 illustrating one example of a chipset implementation of various aspects of the present disclosure discussed above. In some aspects, system 700 may be an example of wireless communications system 100 illustrated in FIG. 1 implemented on one or more UEs 115.

In some examples, the system 700 may include an application processor (AP) 705 in communication with a cellular modem 735 via interface 725. One or more features illustrated in system 700 may be provided on a single chipset or multiple chipsets. In accordance with aspects of the present disclosure, the applications processor 705 may include a high level operating system (HLOS) 710 for managing hardware and software resources of the UE 115. In some aspects, the HLOS 710 may function as an intermediary between software (e.g., programs or applications) executed on the UE 115 and the hardware implementation (e.g., apparatus 400 illustrated in FIG. 4).

Additionally or alternatively, the applications processor 705 may include a WLAN supplicant 715 for making authentication requests (e.g., login requests) to the wireless network associated with the authentication procedures. In some aspects, the WLAN supplicant 715 may handle encryption credentials to the authentication server associated with the small cell AP 120. The WLAN supplicant 715 may be communicatively coupled to the WLAN driver 720 and WLAN modem 730. The WLAN driver 720 may provide software interface to hardware devices, enabling the HLOS 710 and other computer programs access to hardware functions without requiring precise knowledge of the hardware being used. In some aspects, the WLAN driver 720 may communicate with the apparatus (e.g., processing system 414) through a bus or communication subsystem to which the one or more hardware connects. The WLAN modem 730 may modulate/demodulate signals associated with establishing WLAN communication with a small cell AP 120.

The system 700 may further include a cellular modem 735 for establishing communication with a cellular network (e.g., WWAN). The cellular modem 735 may include NAS layer 315 that may be an example of NAS layer 315 described with reference to FIGS. 3A-3C. The NAS layer 315 may form the highest stratum of the control plane between the UE 115 and MME. The NAS layer may be coupled to data service neutral host network (DS_NHN) 750 that may be above the EAP layer 310. The DS_NHN 750 may allow the NAS layer 315 to access and provide realizations of the interactions and optimizations in accordance with various aspects of the present disclosure. In some examples, the EAP layer 310 may be an example of the EAP layer 310 discussed above in FIGS. 3A-3C. The EAP layer 310 may be communicatively coupled with the SIM driver 770 and the USIM card 775. In some aspects, EAP-Authentication and Key Agreement (EAP-AKA) may be based on the smart card such as USIM card 775.

The cellular modem 735 may further include radio resource control (RRC) 755 protocol layer coupled with the LTE protocol stack layer 765 for establishing, configuring, and maintaining RRC connection between UE 115 and the base stations 105. Specifically, the main services and functions of the RRC 755 protocol layer may include broadcast of system information related to the NAS. In some aspects, the broadcast of system information may be related to the access stratum (AS), paging, establishment, maintenance and release of an RRC connection between the UE 115 and E-UTRAN. Additionally or alternatively, the RRC 755 protocol layer may be responsible for security functions including key management, establishment, configuration, maintenance and release of point to point radio bearers. Additionally or alternatively, the LTE protocol stack layer 765 may be an implementation of L2 and L3 protocols according to 3GPP E-UTRA.

The detailed description set forth above in connection with the appended drawings describes example embodiments and does not represent all the embodiments that may be implemented or that are within the scope of the claims. The term “exemplary,” as used in this description, means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, electrically erasable programmable read only memory (EEPROM), compact disk (CD) ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are new releases of Universal Mobile Telecommunications System (UMTS) that use E-UTRA. UTRA, E-UTRA, UMTS, LTE, LTE-A, and Global System for Mobile Communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description above, however, describes an LTE system for purposes of example, and LTE terminology is used in much of the description above, although the techniques are applicable beyond LTE applications.

What is claimed is:

1. A method for wireless communications, comprising:
initiating, at a user equipment (UE), an attachment procedure with a network over a non-access stratum (NAS) layer;
detecting, at the UE, a condition of an extensible authentication protocol (EAP) layer, wherein the condition is associated with the attachment procedure;
determining whether the condition associated with the attachment procedure can be resolved before failure in the attachment procedure; and
invoking a trigger based on the determining, wherein the trigger identifies whether to proceed with the attachment procedure at the NAS layer.

2. The method of claim 1, wherein determining whether the condition associated with the attachment procedure can be resolved before failure in the attachment procedure comprises:
determining that the condition associated with the attachment procedure can be resolved before failure in the attachment procedure; and
suspending a timer associated with the attachment procedure at the NAS layer based on determining that the condition can be resolved before failure in the attachment procedure.

3. The method of claim 2, wherein suspending the timer associated with the attachment procedure comprises identifying a length of time that the timer is to remain suspended.

4. The method of claim 1, wherein determining whether the condition associated with the attachment procedure can be resolved comprises:
determining that the condition associated with the attachment procedure can be resolved before failure in the attachment procedure;
identifying a period of time to extend a timer based on the determining that the condition associated with the attachment procedure can be resolved before failure in the attachment procedure; and
extending, at the UE, the timer associated with the attachment procedure at the NAS layer for the identified period of time.

5. The method of claim 1, wherein determining whether the condition associated with the attachment procedure can be resolved before failure in the attachment procedure comprises:
determining that the condition associated with the attachment cannot be resolved; and
aborting the attachment procedure with the network at the NAS layer based on the determining that the condition associated with the attachment cannot be resolved.

6. The method of claim 5, further comprising:
initiating a fallback attachment procedure with the network via a different base station over the NAS layer, wherein the different base station is a small cell base station or a macro cell base station.

7. The method of claim 1, further comprising:
computing a common security key prior to completing an EAP procedure or receiving an EAP-Success message from the base station; and
communicating the common security key to the NAS layer, wherein the NAS layer utilizes the common security key to establish communication with the network.

8. The method of claim 1, wherein the attachment procedure comprises authentication and key agreement between a base station and the UE.

9. The method of claim 1, further comprising:
determining to proceed or disengage with the attachment procedure at the NAS layer based on the trigger.

10. The method of claim 1, wherein the condition delays authentication with the network.

11. The method of claim 1, wherein initiating the attachment procedure with the network over the NAS layer comprises establishing communication with the network via a small cell base station.

12. An apparatus for wireless communications, comprising:
means for initiating, at a user equipment (UE), an attachment procedure with a network over a non-access stratum (NAS) layer;
means for detecting, at the UE, a condition of an extensible authentication protocol (EAP) layer, wherein the condition is associated with the attachment procedure;
means for determining whether the condition associated with the attachment procedure can be resolved before failure in the attachment procedure; and
means for invoking a trigger based on the determining, wherein the trigger identifies whether to proceed with the attachment procedure at the NAS layer.

13. The apparatus of claim 12, wherein means for determining whether the condition associated with the attachment procedure can be resolved before failure in the attachment procedure comprises:
means for determining that the condition associated with the attachment procedure can be resolved before failure in the attachment procedure; and
means for suspending a timer associated with the attachment procedure at the NAS layer based on determining that the condition can be resolved before failure in the attachment procedure.

14. The apparatus of claim 13, wherein means for suspending the timer associated with the attachment procedure comprises means for identifying a length of time that the timer is to remain suspended.

15. The apparatus of claim 12, wherein means for determining whether the condition associated with the attachment procedure can be resolved comprises:
means for determining that the condition associated with the attachment procedure can be resolved before failure in the attachment procedure;
means for identifying a period of time to extend a timer based on the determining that the condition associated with the attachment procedure can be resolved before failure in the attachment procedure; and
means for extending, at the UE, the timer associated with the attachment procedure at the NAS layer for the identified period of time.

16. The apparatus of claim 12, wherein means for determining whether the condition associated with the attachment procedure can be resolved comprises:
means for determining that the condition associated with the attachment cannot be resolved; and
means for aborting the attachment procedure with the network at the NAS layer based on the determining that the condition associated with the attachment cannot be resolved.

17. The apparatus of claim 16, further comprising:
means for initiating a fallback attachment procedure with the network via a different base station over the NAS layer, wherein the different base station is a small cell base station or a macro cell base station.

18. The apparatus of claim 12, further comprising:
means for computing a common security key prior to completing an EAP procedures or receiving an EAP-Success message from a base station; and
means for transmitting the common security key to the NAS layer, wherein the NAS layer utilizes the common security key to establish communication with the network.

19. The apparatus of claim 12, wherein the attachment procedure comprises authentication and key agreement between a base station and the UE.

20. The apparatus of claim 12, further comprising:
means for determining to proceed or disengage with the attachment procedure at the NAS layer based on the trigger.

21. The apparatus of claim 12, wherein the condition delays authentication with the network.

22. A computer-readable medium storing code for wireless communications, the code comprising instructions executable by a computer to:
initiate, at a user equipment (UE), an attachment procedure with a network over a non-access stratum (NAS) layer;
detect, at the UE, a condition of an extensible authentication protocol (EAP) layer, wherein the condition is associated with the attachment procedure;
determine whether the condition associated with the attachment procedure can be resolved before failure in the attachment procedure; and
invoke a trigger based on the determining, wherein the trigger identifies whether to proceed with the attachment procedure at the NAS layer.

23. The computer-readable medium of claim 22, wherein the code comprising instructions is further executable by the computer to:
determine that the condition associated with the attachment procedure can be resolved before failure in the attachment procedure; and
suspend a timer associated with the attachment procedure at the NAS layer based on determining that the condition can be resolved before failure in the attachment procedure.

24. The computer-readable medium of claim 22, wherein the code comprising instructions is further executable by the computer to:
determine that the condition associated with the attachment procedure can be resolved before failure in the attachment procedure;
identify a period of time to extend a timer based on the determining that the condition associated with the attachment procedure can be resolved before failure in the attachment procedure; and
extend, at the UE, the timer associated with the attachment procedure at the NAS layer for the identified period of time.

25. The computer-readable medium of claim 22, wherein the code comprising instructions is further executable by the computer to:
determine that the condition associated with the attachment cannot be resolved; and
abort the attachment procedure with the network at the NAS layer based on the determining that the condition associated with the attachment cannot be resolved.

26. The computer-readable medium of claim 25, wherein the code comprising instructions is further executable by the computer to:
initiate a fallback attachment procedure with the network via a different base station over the NAS layer, wherein the different base station is a small cell base station or a macro cell base station.

27. The computer-readable medium of claim 22, wherein the code comprising instructions is further executable by the computer to:
compute a common security key prior to completing an EAP procedures or receiving an EAP-Success message from a base station; and
transmit the common security key to the NAS layer, wherein the NAS layer utilizes the common security key to establish communication with the network.

28. A method for wireless communication, comprising:
initiating, at a network entity, an attachment procedure with a user equipment (UE);
detecting, at the network entity, a condition associated with the attachment procedure, wherein the condition delays authentication with the UE;
determining whether the condition associated with the attachment procedure can be resolved before failure in the attachment procedure; and
suspending a timer at the network entity based on the determining, wherein suspending the timer at the network entity allows additional time for the UE to complete the attachment procedure.

29. The method of claim 28, further comprises:
identifying a period of time to extend the timer based on anticipated delay in completing authentication with the UE; and
extending the timer at the network entity for the period of time.

30. The method of claim 28, wherein suspending the timer at the network entity is based on a predetermined configuration parameter established between the network entity and the UE.
